(19) United States
(12) Patent Application Publication
(10) Pub. No.: US 2023/0024049 A1
(43) Pub. Date: Jan. 26, 2023

(54) Footrest Assembly For Use With A Wheelchair

(71) Applicants: Nechelle Baldwin, Stone Mountai, GA (US); Simone Floyd, College Park, GA (US); Howard Martin, Conyers, GA (US)

(72) Inventors: Nechelle Baldwin, Stone Mountai, GA (US); Simone Floyd, College Park, GA (US); Howard Martin, Conyers, GA (US)

(21) Appl. No.: 17/384,885

(22) Filed: Jul. 26, 2021

(51) Int. Cl. A61G 5/12

(52) U.S. Cl. CPC A61G 5/128; A61G 2200/34

(57) ABSTRACT

Disclosed is a footrest assembly for use with a wheelchair. The footrest assembly includes a platform, and a plurality of strap fasteners. The platform is configured to support the feet of a wheelchair occupant. The platform includes a top surface that includes a female strip with a plurality of hooks. The wheelchair includes a male strip with a plurality of loops placed under a seat of the wheelchair. The plurality of hooks and the plurality of loops are removably latch onto one another when the female strip and the male strip are pressed together. Each of the strap fasteners having a plurality of proximal ends detachably attached with a vertical frame of the wheelchair, and a plurality of distal ends detachably attached with the platform to hold the platform above a ground surface.

### TECHNICAL FIELD

The presently disclosed embodiments are related, in general, to a footrest assembly. More particularly, the presently disclosed embodiments are related to the footrest assembly use on wheelchairs.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in-and-of-themselves may also be inventions.

Typically, wheelchairs are provided with two attachable footrests, each having one footrest on which the person sitting in the wheelchair can place his or her feet. Traditionally, wheelchairs have metal or plastic footrests that can only rotate vertically which is a nuisance. Further, the obstruction with the user's feet and the footrest when not in use has been a stressful experience which can also result in injury due to accidents. A couple of prior arts provide a solution to solve similar problems such as U.S. Pat. No. 5,842,745 issued to Kelly, et al. discloses an improved wheelchair and upper body support for supporting an occupant of the wheelchair. The wheelchair has two spaced-apart armrests for supporting the occupant. Upper body support is mounted on each of the spaced-apart armrests and includes a base member that has a front end and a back end. body support further includes a padded back wall that is attached to the base member and that provides support for the occupant when an arm of the occupant is leaned thereon. The upper body support further includes a padded sidewall that is attached to the base member and provides support for the occupant when the occupant's arm is leaned thereon. A mechanism is also provided for securing each upper body support to one of the spaced-apart armrests. The padded back wall is removably attached to the base member so that the occupant may operate the wheelchair when the padded back wall is removed.

Further, U.S. Pat. No. 8,191,913 issued to Jessome discloses a center footrest apparatus for use on an existing wheelchair comprises a foot resting plate arranged in a sling-like manner and attached to each side of the chair frame. The apparatus is further provided in a second embodiment comprising a rigidly mounted and height-adjustable center footrest portion supported by a T-bar that attaches to the chair frame. The center footrest allows a person to be moved around in tight quarters without interference caused by conventional folding dual footrests.

However, the existing footrest assemblies connected with the wheelchair are not user-friendly. Therefore, there is a necessity for a footrest assembly that can be used with any wheelchair to better maintain the feet on the wheelchair.

Thus, in view of the above, there is a long-felt need in the health industry to address the aforementioned deficiencies and inadequacies.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments illustrated herein, there may be provided a footrest assembly for use with a wheelchair. The footrest assembly includes a platform and a plurality of strap fasteners. The platform is configured to support the feet of a wheelchair occupant. The platform includes a top surface that includes a female strip with a plurality of hooks. The wheelchair includes a male strip with a plurality of loops placed under a seat of the wheelchair. The plurality of hooks and the plurality of loops are removably latched onto one another when the female strip and the male strip are pressed together. Each of the strap fasteners having a plurality of proximal ends detachably attached with a vertical frame of the wheelchair, and a plurality of distal ends detachably attached with the platform to hold the platform above a ground surface.

In an aspect, the female strip divides the top surface into at least two portions to support the feet of the wheelchair occupant.

In an aspect, tire platform is sized to fit between a plurality of front wheels of the wheelchair.

In an aspect, the platform is made of at least one a natural fabric, a synthetic fabric, and a combination of the natural fabric and the synthetic fabric thereof.

In an aspect, the footrest assembly includes a plurality of adjusters connected with each of the plurality of strap fasteners to adjust the height of the platform.

In an aspect, the top surface of the platform is a textured surface.

In an aspect, the platform includes a bottom surface having a textured surface.

In an aspect, the footrest assembly includes a plurality of attachment extensions removably affixed to the vertical frame of the wheelchair for facilitating the user to detachably attach the strap fasteners during assembly, wherein at least one of the attachment extensions is affixed to either a left vertical frame or a right vertical frame of the embodiment and adjusted for the height.

Accordingly, one advantage of the present invention is that the footrest assembly can be detachably attached under the wheelchair-seat area to avoid any contact from the user's feet.

Accordingly, one advantage of the present invention is that the footrest assembly can be attached under the seat of the wheelchair by using VELCRO® (hook and loop fastener) or other types of attachment to free the user from contact with the footrest assembly.

These and other features and advantages of the present disclosure may be appreciated from a review of the following detailed description of the present disclosure, along with the accompanying figures in which reference numerals refer to like parts throughout.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a perspective view of a footrest assembly for use with a wheelchair, in accordance with at least one embodiment.

FIG. 2 is a top view of the platform, in accordance with at least one embodiment.

FIG. 3 is a bottom view of the platform, in accordance with at least one embodiment.

FIG. 4 illustrates a perspective view of the attachment extensions removably affixed to the vertical frame of the wheelchair, in accordance with at least one embodiment.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the apparatuses, methods, and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled” as used herein, is defined as connected, although not necessarily directly, and not necessarily mechanically.

Headings of sections provided in this patent application and the title of this patent application are for convenience only and are not to be taken as limiting the disclosure in any way. A description of an embodiment with several components in connection with each other does not imply that all such components are required.

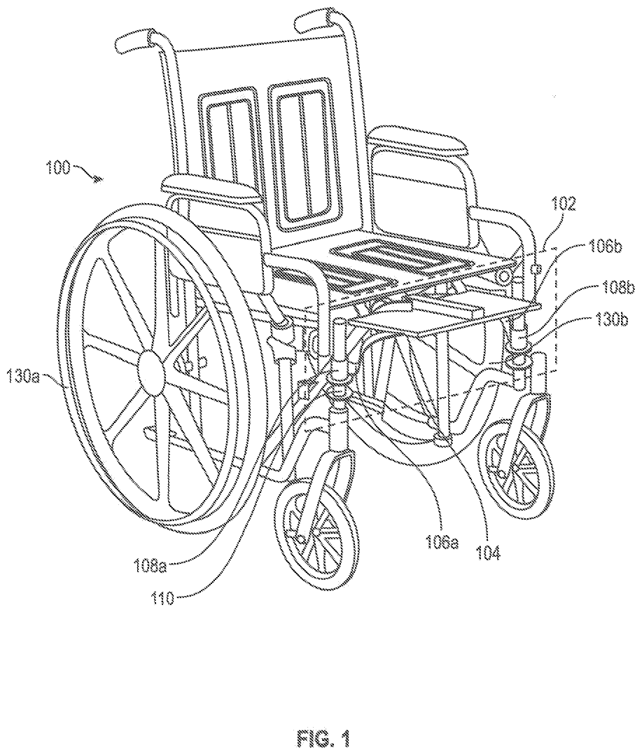

FIG. 1 is a perspective view of a footrest assembly (102) for use with a wheelchair (100), in accordance with at least one embodiment. The footrest assembly (102) includes a platform (104), and a plurality of strap fasteners (106a, and 106b). The platform (104) is configured to support the feet of a wheelchair occupant. The platform (104) includes a top surface (202) that includes a female strip (204) with a plurality of hooks. In an embodiment, the female strip (204) divides the top surface (202) into at least two portions (206a, and 206b) to support the feet of the wheelchair occupant. In an embodiment, the female strip (204) is a rolled-up female tape, which is a part of the VELCRO® with its adhering face facing outwards and being packed in one portion of a transparent plastic case.

The footrest assembly (102) includes a plurality of adjusters connected with each of the plurality of strap fasteners (106a, and 106b) to adjust the height of the platform. In an embodiment, the height of the strap fasteners (106a, and 106b) can be adjusted via a plurality of Velcro® attachments.

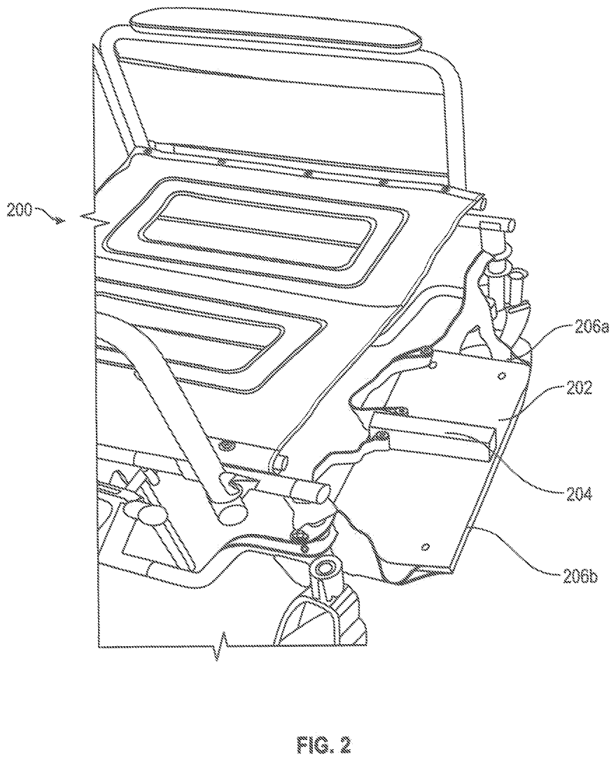

FIG. 2 is a top view of the platform (104), in accordance with at least one embodiment. In an embodiment, the platform (104) is sized to fit between a plurality of front wheels (130a, and 130b) of the wheelchair (100). In a non-limiting example, the platform (104) is made of at least one a natural fabric, a plastic, a synthetic fabric, and a combination of the natural fabric and the synthetic fabric thereof. Examples of the natural fabric include but are not limited to wool, cotton, silk, and linen are made from animal coats, cotton-plant seed pods, fibers from silkworms, and flax (fiber from the stalk of a plant), respectively. Examples of synthetic fabric include but are not limited to nylon, spandex, rayon, polyester, and acrylic are man-made. The top surface (202) of the platform (104) is a textured surface.

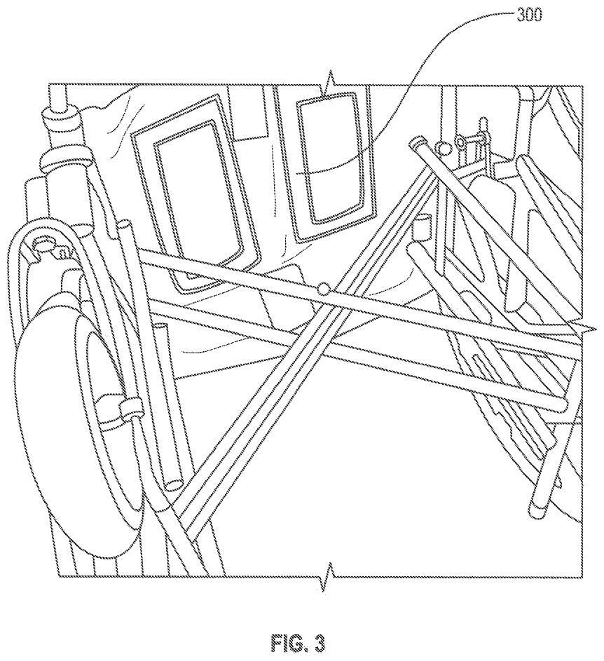

FIG. 3 is a bottom view of the platform (104), in accordance with at least one embodiment. The platform (104) includes a bottom surface having a textured surface. The wheelchair (100) includes a male strip (300) with a plurality of loops placed under a scat of the wheelchair (100). The plurality of hooks and the plurality of loops are removably latch onto one another when the female strip and the male strip are pressed together.

In an embodiment, the male strip (300) is a rolled-up male tape, which is a part of the VELCRO® with its adhering face facing outwards and being packed in one portion of said transparent plastic case abreast with the female tape. Each of the strap fasteners (106a, and 106b) having a plurality of proximal ends (108a, and 108b) detachably attached with a vertical frame (110) of the wheelchair (100), and a plurality of distal ends detachably attached with the platform to hold the platform (104) above a ground surface.

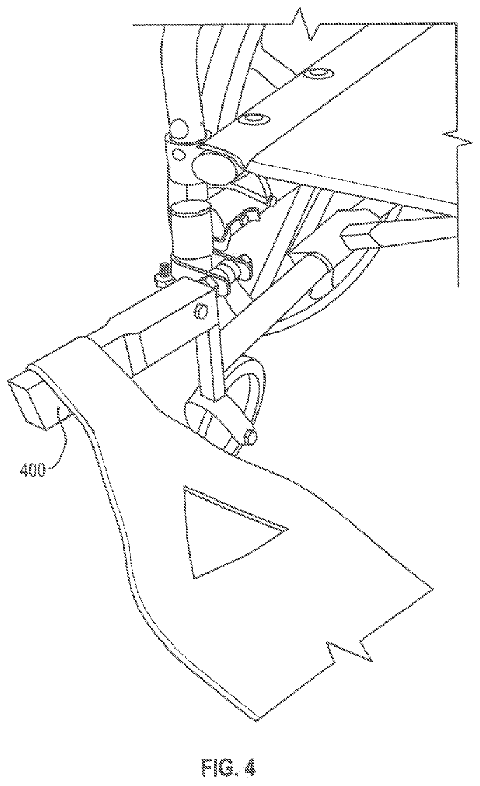

FIG. 4 illustrates a perspective view of the attachment extensions removably affixed to the vertical frame (110) of the wheelchair (100), in accordance with at least one embodiment. The footrest assembly (102) includes a plurality of attachment extensions (400) removably affixed to the vertical frame (110) of the wheelchair (100) for facilitating the user to detachably attach the strap fasteners (106a, and 106b) during assembly. In an embodiment, at least one of the attachment extensions (400) is affixed to either a left vertical frame (110a) or a right vertical frame (110b) of the vertical frame (110) and adjusted for the height.

Thus, the present invention provides a footrest assembly that can be detachably attached under the wheelchair-seat area to avoid any contact from the user's feet.

A person skilled in the art will understand that the footrest assembly (102) is described herein for illustrative purposes and should not be construed to limit the scope of the disclosure.

A person with ordinary skills in the art will appreciate that the apparatuses and devices have been illustrated and explained to serve as examples and should not be considered limiting in any manner. It will be further appreciated that the variants of the above-disclosed system elements, modules, and other features and functions, or alternatives thereof, may be combined to create other different apparatuses, systems, or applications.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A footrest assembly for use with a wheelchair, comprising:
a platform to support feet of a wheelchair occupant, wherein the platform comprising:
a top surface comprising a female strip with a plurality of hooks, wherein the wheelchair comprising a male strip with a plurality of loops placed under a seat of the wheelchair, whereby the plurality of hooks and the plurality of loops are removably latch onto one another when the female strip and the male strip are pressed together; and
a plurality of strap fasteners each having a plurality of proximal ends detachably attached with a vertical frame of the wheelchair, and plurality of distal ends detachably attached with the platform to hold the platform above a ground surface.

2. The footrest assembly as claimed in claim 1, wherein the female strip divides the top surface into at least two portions to support feet of the wheelchair occupant.

3. The footrest assembly as claimed in claim 1, wherein the platform is sized to fit between a plurality of front wheels of the wheelchair.

4. The footrest assembly as claimed in claim 1, wherein the platform is made of at least one a natural fabric, a synthetic fabric, a plastic, and a combination of the natural fabric and the synthetic fabric thereof.

5. The footrest assembly as claimed in claim 1 comprising a plurality of adjusters connected with each of the plurality of strap fasteners to adjust the height of the platform.

6. The footrest assembly as claimed in claim 1, wherein the top surface of the platform is a textured surface.

7. The footrest assembly as claimed in claim 1, wherein the platform comprising a bottom surface having the textured surface.

8. The footrest assembly as claimed in claim 1 comprising a plurality of attachment extensions removably affixed to the vertical frame of the wheelchair for facilitating the user to detachably attach the strap fasteners during assembly, wherein at least one of the attachment extensions is affixed to either a left vertical frame or a vertical frame of the vertical frame and adjusted for the height.
